(19) United States
(12) Patent Application Publication
(10) Pub. No.: US 2008/0162952 A1
(43) Pub. Date: Jul. 3, 2008

(54) MANAGING POWER USAGE IN A DATA PROCESSING SYSTEM BY CHANGING THE CLOCK SPEED OF A PROCESSING UNIT

(76) Inventors: John David Landers, Raleigh, NC (US); David John Steiner, Raleigh, NC (US); Paul Morton Wilson, Cary, NC (US); Kimberly Ann Wood, Raleigh, NC (US)

Correspondence Address: DUKE W. YEE;YEE & ASSOCIATES, P.C., P.O. BOX 802333, DALLAS, TX, 75380, US

(21) Appl. No.: 11/619,207

(22) Filed: Jan. 3, 2007

(51) Int. Cl. G06F 1/00

(52) U.S. Cl. 713/300

(57) ABSTRACT

A computer implemented method for managing power usage in a data processing system. Power usage by a set of input/output devices attached to the data processing system is monitored. If it is determined that the power usage requires a change in power consumption by a processing unit, the clock speed of the processing unit is changed to change the power consumption by the processing unit.

### BACKGROUND OF THE INVENTION

1. Field of the Invention

The present invention relates generally to data processing systems and in particular, the present invention relates to a method and computer program product for managing power usage. Still more particularly, the present invention relates to a computer implemented method, apparatus, and computer program product for managing a power usage of a data processing system by changing the clock speed of a processing unit.

2. Description of the Related Art

A point of sale (POS) terminal is a data processing system that has been tailored for processing retail sales transactions. The physical dimensions of the point of sale terminal are constrained by many factors, including the width of the checkout lanes and the size of the currency being handled. The constraints on the physical dimensions of the point of sale terminal also constrain the size of the power supply used in the point of sale terminal.

The power supply in the point of sale terminal provides power to a main circuit board and to peripheral devices, such as scanners and printers connected to the point of sale terminal. As processors become faster and as more peripheral devices are connected to the point of sale terminal, the power supply in the point of sale terminal is asked to supply more power. However, the power supply cannot be redesigned to supply more power because redesigning the power supply would make it larger and violate the constraints placed on the physical size of the power supply.

Therefore, demand for power in the point of sale terminal continues to increase, but it is not possible to increase the size of the power supply to accommodate the increased need for power, limiting the power available to peripheral devices. Because of the limited power available to the peripheral devices, some peripheral devices may operate slower than they are capable of or may not operate at all, resulting in longer retail sales transactions.

### BRIEF SUMMARY OF THE INVENTION

The different embodiments provide a computer implemented method for managing power usage in a data processing system. Power usage by a set of input/output devices attached to the data processing system is monitored. If it is determined that the power usage requires a change in power consumption by a processing unit, a clock speed of the processing unit is changed to change the power consumption by the processing unit.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of a point of sale terminal in accordance with an illustrative embodiment;

FIG. 4 is a flowchart of a process in a point of sale terminal in accordance with an illustrative embodiment; and

FIG. 5 is a flowchart for determining the power consumption of a peripheral in accordance with an illustrative embodiment.

### DETAILED DESCRIPTION OF THE INVENTION

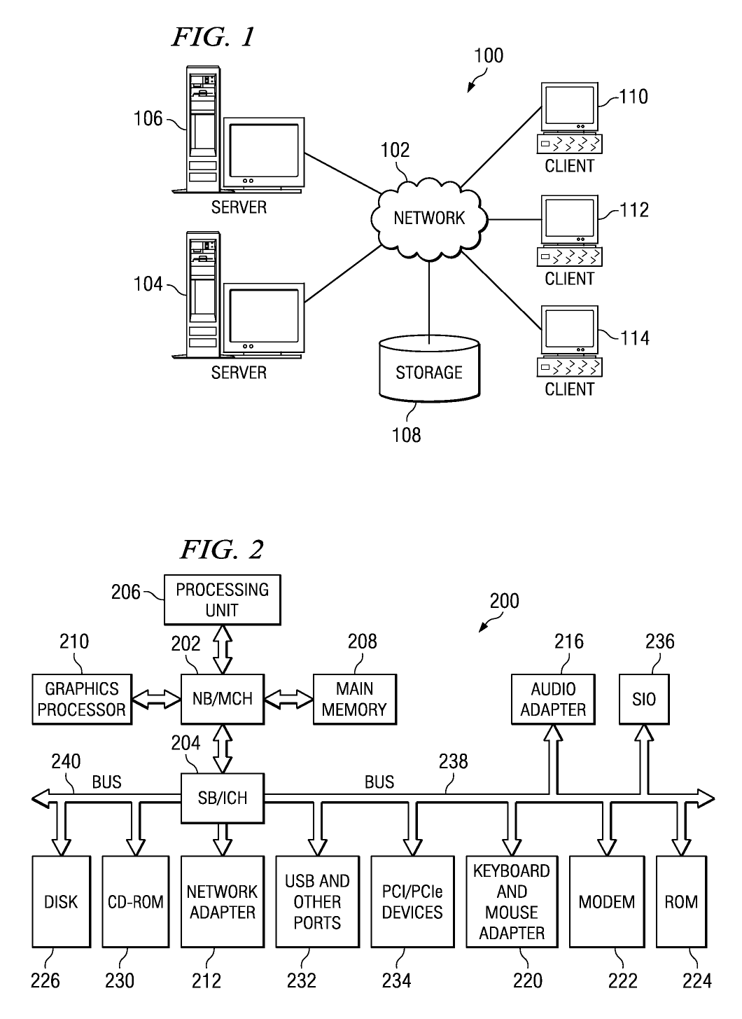

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

Clients 110, 112, and 114 may be point of sale terminals used to checkout retail customers. Servers 104 and 106 may contain databases with information on product prices. Storage 108 may contain credit card information which servers 104 and 106 use to verify a credit card presented at clients 110, 112 and 114.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200. Java and all Java-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, optical disk drives, printers, or point of sale peripheral devices may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a point of sale terminal, tablet computer, laptop computer, or telephone device in addition to taking the form of a PDA.

In a conventional point of sale terminal, there are many peripheral devices connected to the point of sale terminal. A peripheral device is any type of input/output device that provides input to the point of sale terminal, takes output from the point of sale terminal, or does both input and output.

For example, an optical scanner may be connected to the point of sale terminal to scan the universal product code (UPC) printed on each product and input the product code to the point of sale terminal. A magnetic stripe reader may be connected to the point of sale terminal to read credit card information and input credit card information into the point of sale terminal. A printer may be connected to the point of sale terminal to take the output of the point of sale terminal and print a receipt, and to print rebates and coupons. A liquid crystal display with a touch screen may serve to display output from the point of sale terminal and to provide input from the touch screen to the point of sale terminal.

Typically, peripheral devices obtain power by connecting to a powered port on the point of sale terminal. The powered port connects the peripheral device to the point of sale terminal and to other peripheral devices that are connected to the point of sale terminal. The powered port also supplies power, such as five volts, twelve volts or twenty-four volts to the peripheral device so the peripheral device does not require a separate power connection. The point of sale terminal may have both powered ports and non-powered ports.

The physical dimensions of the point of sale terminal are constrained by factors, such as width of the checkout lanes and size of the currency being handled. The constraints on the physical dimensions of the point of sale terminal also constrain the size of the power supply used in the point of sale terminal. The power supply in the point of sale terminal provides power to a main circuit board and to peripheral devices, such as scanners and printers connected to the point of sale terminal. As processing units become faster and as more peripheral devices are connected to the point of sale terminal, the power supply in the point of sale terminal is required to supply more power.

Redesigning the power supply to provide more power typically increases the power supply. However, a larger power supply violates the constraints placed on the physical dimensions of the power supply due to the physical dimensions of the point of sale terminal. Therefore, redesigning the power supply to provide more power is not a viable option.

Usually, the processing unit and the peripheral devices are not all using power at the same time. For example, when the printer is active, the processing unit and other peripheral devices may be relatively inactive. Therefore, there is a need to manage the power used by the processing unit and by peripheral devices connected to the point of sale terminal.

In a conventional cash register, a receipt is typically printed one line at a time in real time. A clerk enters one product identifier after another, receives payment from the computer, and completes the transaction. Almost immediately after the clerk enters the product identifier, an entry for that product is printed on the receipt. When the transaction is complete, the conventional cash register prints the amount due, amount tendered, and any changed owed to the customer, and the printing of the receipt is completed.

In a point of sale terminal, all printing is typically done at or near the end of the transaction. The clerk scans or enters product identifiers, the customer tenders payment, and only after payment is completed, does the receipt print out. The point of sale terminal may also print additional items at the same time the receipt is printed, such as credit card authorization, coupons, rebate forms, and rebate receipts. Some of these additional printed items may be printed based on a list of purchased products in the receipt. For example, purchasing a box of cereal might trigger the printing of a coupon for milk or for a different brand of cereal.

A printer attached to a point of sale terminal is thus idle when a retail sales transaction is in progress. While the printer is idle, the printer draws a minimal amount of power. However, when the transaction is completed, the printer prints the receipt and possibly other related items. When the printer is printing, the printer typically draws more power than when the printer is idle.

In contrast, the processing unit of the point of sale terminal is processing information up until the transaction is completed and is idle while printing occurs. For example, as each product is scanned or entered into the point of sale terminal, the processing unit determines a current price for the product and notes it in preparation for printing the receipt. When the customer tenders payment, the processing unit calculates the change owed if cash was tendered or authorizes a credit card if the credit card was tendered. Once the clerk has entered all products and the customer has tendered payment, the processing unit sends the printer the information needed to print the receipt.

Thus, the printer is relatively inactive during the transaction but is active when the transaction is completed. Other peripheral devices attached to the point of sale terminal go through similar periods of activity and inactivity. This means that the processing unit and the peripheral devices do not all demand power at once but instead take turns using power.

In a conventional point of sale terminal, the printer is constrained to print at a particular speed based on the maximum power the power supply is capable of producing. The printer typically uses more power when it prints quickly and uses less power when it prints slowly. If both the printer and the processing unit are using power, then the printer has to print slowly so as not to exceed the maximum power available.

For example, suppose the power supply can supply a maximum of 300 watts, and the processing unit uses 100 watts. Assume also that the printer uses 150 watts when printing twenty-five lines per second (LPS), 200 watts when printing fifty lines per second, and 250 watts when printing seventy-five lines per second. In this example, when the processing unit and printer are both using power, the power supply has 300−100=200 watts available for the printer. The printer is therefore constrained to print at no more than fifty lines per second. If, when the printer is printing, the processing unit used only 50 watts, then the printer could print at up to seventy-five lines per second.

The processing unit operates at a speed which is controlled by a clock. Generally, the faster the speed of the clock, the more power the processing unit uses, and the slower the speed of the clock, the less power the processing unit uses. Typically, processing a retail sales transaction is not a computationally intensive activity, and so slowing down the processing unit does not significantly slow the speed at which the transaction is processed. Therefore, the illustrative embodiments recognize that by reducing the clock speed of the processing unit, the processing unit uses less power, thereby making power available for other peripheral devices.

Thus, the different embodiments provide a computer implemented method for managing power usage in a data processing system. Power usage by a set of input/output devices attached to the data processing system is monitored. If it is determined that the power usage requires a change in power consumption by the processing unit, the clock speed of the processing unit is changed to change the power consumption by the processing unit.

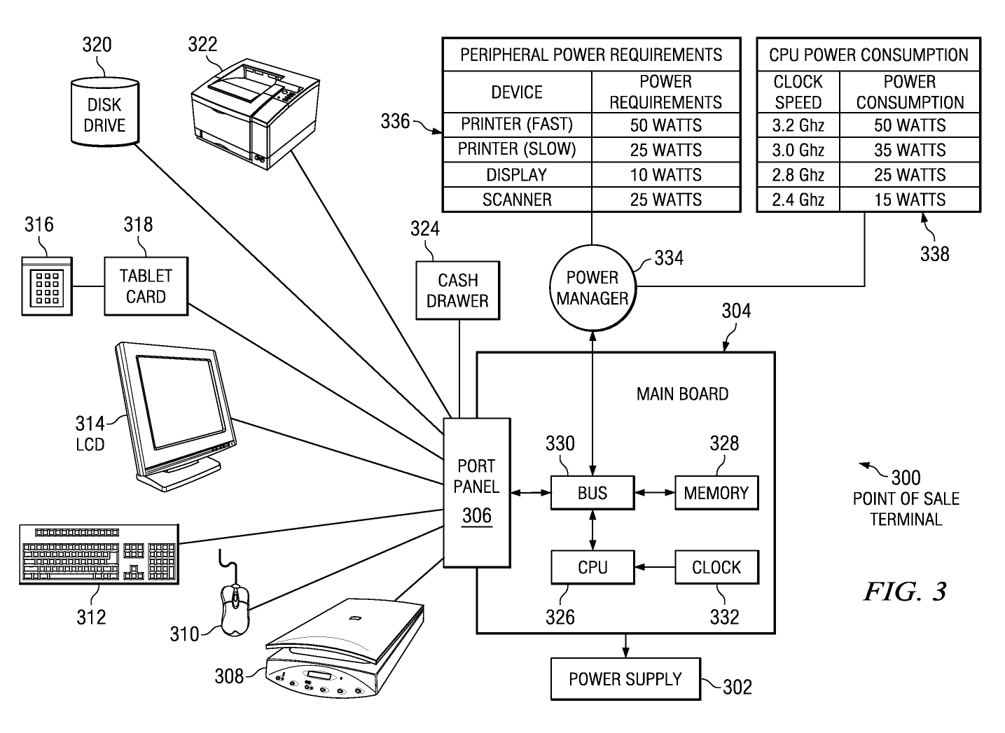

Turning now to FIG. 3, a block diagram of a point of sale terminal is shown in accordance with an illustrative embodiment. Point of sale terminal 300 is a computer, such as data processing system 200 in FIG. 200, tailored for processing retail sales transactions. In this example, point of sale terminal 300 is a client, such as client 110, attached to a network, such as network 102 in FIG. 1.

Power supply 302 provides power to main board 304 and to various peripheral devices attached to main board 304. Peripheral devices connect to a port on port panel 306. Port panel 306 contains a variety of ports, such as RS232 (serial), Universal Serial Bus (USB), and personal system 2 (PS/2) ports.

Some of the ports on port panel 306 may be powered, while other ports may not be powered. A powered port provides power, such as five volts, twelve volts, or twenty-four volts to the peripheral device connected to the powered port, so that the peripheral device does not require a separate power supply. Port panel 306 may be mounted directly to the main board itself, or port panel 306 may be mounted on a remote panel. Those skilled in the art will appreciate that main board 304 may have more than one port panel.

Additional peripheral devices that may be attached to main board 304 include optical scanner 308, mouse 310, keyboard 312, liquid crystal display (LCD) 314, magnetic stripe reader (MSR) 316, tablet card 318, disk drive 320, printer 322, and cash drawer 324. Of course, one versed in the art will appreciate that additional peripheral devices may also be added to point of sale terminal 300.

In addition to port panel 306, main board 304 also contains central processing unit (CPU) 326, memory 328, bus 330, and clock 332. For example, CPU 326 may be processing unit 206 in FIG. 2, memory 328 may be main memory 208 in FIG. 2, and bus 330 may be bus 238 or bus 240 in FIG. 2.

Power manager 334 is software which manages the use of power by the various components of point of sale terminal 300. Those versed in the art will appreciate that power manager 334 may be software stored on disk drive 320, may be firmware embedded into main board 304, or a combination of software and firmware. Power manager 334 uses bus 330 to send messages to and receive messages from the various components of point of sale terminal 300.

Optionally, power manager 334 accesses peripheral power requirements table 336. Each record in peripheral power requirements table 336 contains information about the power requirements of various components of point of sale terminal 300. Peripheral power requirements table 336 may be populated in several different ways. For example, peripheral power requirements table 336 may be populated when main board 304 is powered on and the various components of point of sale terminal 300 are recognized.

Peripheral power requirements table 336 may also be dynamically updated. For example, when a new peripheral device is plugged into a USB port on port panel 306, the peripheral device may indicate the maximum amount of power the peripheral device uses. If the peripheral device indicates the amount of power the peripheral device uses, then power manager 334 stores that information in peripheral power requirements table 336. However, if the peripheral device does not indicate the amount of power the peripheral device uses, then power manager 334 may measure the power usage of the device and store the peripheral device's power usage in peripheral power requirements table 336.

Power manager 334 manages the power used by processing unit CPU 326 by adjusting the speed of clock 332. The speed at which CPU 326 operates is regulated by clock 332. By slowing down clock 332, power manager 334 slows down the speed at which CPU 326 operates. Power manager 334 may use a table, such as CPU power consumption table 338 to determine a clock speed based on the power requirements. CPU power consumption table 338 may, for example, provide a list of clock speeds and the amount of power consumed at each clock speed. The slower the speed of clock 332 and CPU 326, the less power CPU 326 consumes. Therefore, power manager 334 can slow down the speed at which CPU 326 operates when power manager 334 determines that other peripheral devices need additional power.

Typically, the main board in a point of sale terminal uses a commercially available central processing unit (CPU). The operating speed (clock speed) of commercially available processing units continues to increase as general computing requirements increase. However, since the introduction of point of sale terminals, operating speeds for processing units have increased substantially, whereas computing requirements have not increased substantially. Therefore, slowing down the operating speed of a processing unit in a point of sale terminal, for example, from 3.2 gigahertz (Ghz) to 2.8 Ghz, typically does not significantly slow down the time taken to process a retail sales transaction.

In fact, slowing down the processing unit may result in significantly faster processing of retail sales transactions. Slowing down the processing unit so that the processing unit consumes less power allows peripheral devices attached to the point of sale terminal to consume more power and perform their tasks faster. Therefore, by slowing down the clock speed of the processing unit, peripheral devices can draw more power and perform their tasks faster, resulting in a faster overall retail sales transaction.

For example, once the total bill has been computed and the customer's payment has been received, the receipt is printed using a printer, such as printer 322, attached to the point of sale terminal. The printer typically requires a significant amount of power, but because the printer shares power with the processing unit, the receipt prints slowly. Typically, when the receipt is printing, the processing unit has already completed processing the transaction and is not doing anything which requires significant amounts of power. Thus, by slowing the processing unit down when the receipt is printing, power manager 334 can increase the printer's printing speed, resulting in faster processing of the retail sales transaction.

Therefore, power manager 334 can adjust the clock speed for CPU 326 based on the power demands made by the components of point of sale terminal 300. For example, printer 322 might send a message to power manager 334 using bus 330 to indicate that printer 322 is about to print something and therefore, printer 322 will be requiring additional power. Power manager 334 can then send a message to clock 332 using bus 330 that causes clock 332 to slow down.

The amount clock 332 is slowed down may be a fixed amount each time. For example, each time a peripheral device signals that the peripheral device will need more power, power manager 334 may reduce clock 332 by twenty-five percent, from 3.2 Ghz to 2.4 Ghz. Alternately, the amount clock 332 is slowed down may be dynamically calculated. For example, power manager 334 may check the power requirements for printer 322 in peripheral power requirements table 336, calculate the amount of clock reduction required to make the required power available to printer 322 using CPU power consumption table 338, and then adjust the speed of clock 332 accordingly.

Power manager 334 may adjust the speed of clock 332 dynamically, so that when, for example, a peripheral device needs more power to perform a task, the speed of clock 332 is reduced. Once the peripheral device has completed the task, the speed of clock 332 is increased. When a peripheral device notifies power manager 334 that the peripheral device needs more power, power manager 334 may optionally query the sales clerk operating the point of sale terminal and ask if the clock speed can be reduced. If the clerk is planning to perform a task which requires a fast processing unit speed, the clerk can refuse the request from power manager 334 to reduce the clock speed.

Power manager 334 may set the speed of clock 332 dynamically in response to peripheral devices indicating a change in their power usage, or power manager 334 may set the speed of clock 332 periodically, such as each time the point of sale terminal is powered on. Power manager 334 may use peripheral power requirements table 336 to calculate power requirements for all the devices in peripheral power requirements table 336 and then set the speed of clock 332 so that there is power left for the other devices. For example, each time point of sale terminal 300 is powered on, power manager 334 may calculate total power consumption of all devices in peripheral power requirements table 336 and set clock 332 accordingly. No further adjustments are made to clock 332 until the next time point of sale terminal 300 is powered-on.

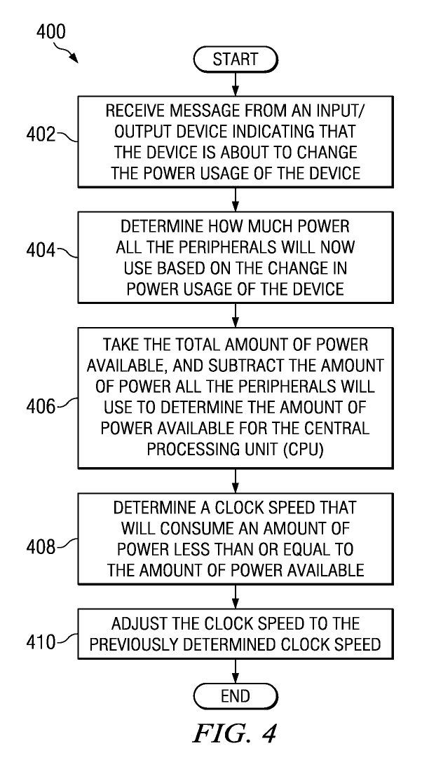

FIG. 4 is a flowchart of a process in a point of sale terminal in accordance with an illustrative embodiment. In this example, the process shown in FIG. 4 is executed by a software process, such as power manager 334 in FIG. 3.

The operation begins when the software process receives a message indicating that a peripheral device, such as printer 322 in FIG. 3, is planning to change the amount of power the peripheral device uses (step 402). For example, the printer, which had been idle and not consuming any power, may send a message indicating that the printer is about to print at a fast rate and consume 50 watts of power. Similarly, when the printer is finished printing, the printer may send a message indicating that the printer is about to go back to being idle and resume consuming no power. The printer may send the message over a bus, such as bus 330 in FIG. 3.

The peripheral device indicates that the peripheral device is about to increase or decrease the amount of power the peripheral device uses. The peripheral device may specify the new amount of power it is planning to utilize or the amount of power the device uses may be determined from a table, such as peripheral power requirements table 336 in FIG. 3.

The software process then calculates the total amount of power which all the peripheral devices will consume based on the new amount of power the peripheral device will utilize (step 404). The software process determines how much power is available for the processing unit by taking the total power available and subtracting the total power the peripherals will consume (step 406).

If the power usage will increase, then a slower clock speed is determined. If the power usage will decrease, then a faster clock speed is determined. The software process determines a new clock speed that draws no more than the amount of power available (step 408). The software process may use a table containing the power consumption for the processing unit at different clock speeds, such as CPU power consumption table 338 in FIG. 3.

Once a new clock speed for the processing unit is determined, a message is sent to the clock, such as clock 332 in FIG. 3, to change the speed of the clock (step 410). The change in clock speed changes the power usage for the processing unit to accommodate the change in the power usage of the peripheral device. The operation then ends.

For example, suppose the power supply can supply a maximum of 300 watts, the processing unit uses 50 watts at a clock speed of 3.2 Ghz. Suppose also that all the peripherals, excluding the printer, use 250 watts, while the printer uses nothing when idle but 25 watts when printing at the printer's maximum speed.

At the end of a retail sales transaction, the printer sends a message indicating that the printer is about to print a receipt and that the printer will consume 50 watts in step 402. The software process calculates that all the peripherals, including the printer, will consume 250+25=275 watts in step 404. The software process then calculates that there is 300−275=25 watts left for the processing unit in step 406. The software process determines that the processing unit will consume 25 watts or less at a clock speed of 2.8 Ghz in step 408. The software process then adjusts the clock speed to 2.8 Ghz so that processing unit consumes 25 watts when the printer begins printing.

Once the printer has completed printing, the printer sends a message indicating that the printer has finished printing and is about to become idle and consume no power, that is 0 watts in step 402. The software process calculates that all the peripherals, including the printer, will consume 250+0=250 watts in step 404. The software process then calculates that there is 300−250=50 watts left for the processing unit in step 406. The software process determines that the processing unit will consume 50 watts or less at a clock speed of 3.2 Ghz in step 408. The software process then adjusts the clock speed to 3.2 Ghz so that processing unit consumes 50 watts. Assume also that the printer uses 150 watts when printing twenty-five lines per second (LPS), 200 watts when printing fifty lines per second, and 250 watts when printing seventy-five lines per second.

Typically, when a peripheral is connected to a point of sale terminal using the universal serial bus (USB), the peripheral has the option to indicate the power usage of the peripheral as part of the universal serial bus connection protocol. If the peripheral does not indicate the power usage of the peripheral, then the point of sale terminal may be capable of measuring the power usage.

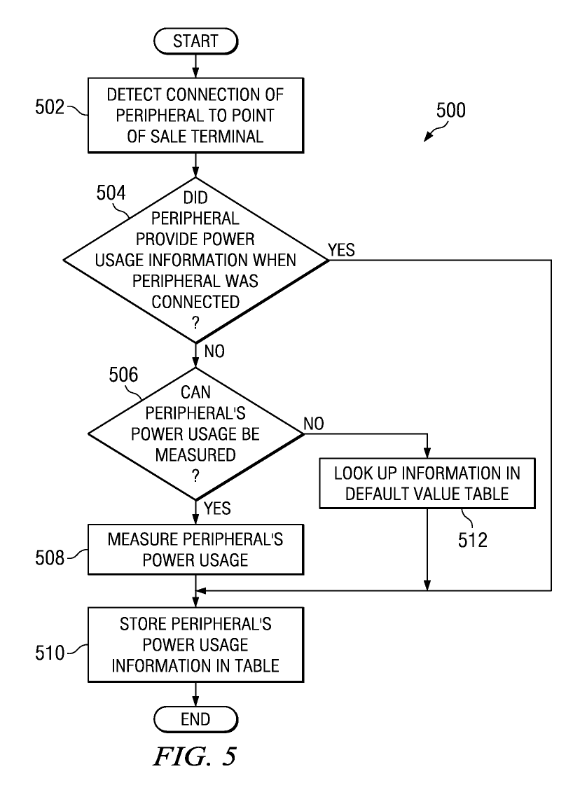

FIG. 5 is a flowchart for determining the power consumption of a peripheral in accordance with an illustrative embodiment. The flowchart in FIG. 5 may be executed by a software process, such as power manager 334 in FIG. 3.

The process begins when the software detects a peripheral connected to the point of sale terminal (step 502). A determination is made as to whether the peripheral indicated the power consumption of the peripheral when the peripheral was connected to the point of sale terminal (step 504). If the answer is “no”, and the peripheral did not indicate the power consumption of the peripheral when the peripheral was connected to the point of sale terminal, then the software process determines whether the power consumption of the peripheral can be measured (step 506).

Step 506 determines whether the point of sale terminal has the necessary hardware and software required to measure the power consumption for the peripheral. If the answer is “yes” and the power consumption of the peripheral can be measured, then the peripheral power usage is measured (step 508). For example, a shunt and analog to digital (A/D) converter may be used to measure the power consumption of a peripheral. The measured power usage is stored in a table, such as peripheral power requirements table 336 in FIG. 3 (step 510) and the process ends.

If the answer to step 506 is “no” because the power usage of the peripheral cannot be measured, then a default value is retrieved (step 512) and the process ends. For example, a table containing power usage for common or popular peripheral devices may be loaded at system startup. The default power usage table may be used when a peripheral device does not indicate the power usage of the device and the point of sale terminal is not capable of measuring the power usage. If in step 504 the software process determines that, “yes”, the peripheral did indicate the power consumption of the peripheral, then the power consumption information is stored in a table (step 510) and the process ends.

The present embodiments provide a computer implemented method for managing power usage in a data processing system. Power usage by a set of input/output devices attached to the data processing system is monitored. If it is determined that the power usage requires a change in power consumption by the processing unit, the clock speed of the processing unit is changed to change the power consumption by the processing unit.

Thus, increased power usage in the point of sale terminal can be accommodated without having to redesign the power supply to make more power. The clock speed for the processing unit in the point of sale terminal can be increased or decreased in response to the power required by the various peripheral devices connected to the point of sale terminal. By varying the clock speed for the processing unit, existing power supplies can accommodate the increased power usage of the processing unit and peripheral devices connected to the point of sale terminal.

In one embodiment, when a peripheral device attached to the point of sale terminal is given a task, the peripheral device indicates that the peripheral device is about to engage in a task that will cause the peripheral device to use more power than it was previously using. When a peripheral device indicates that it is about to start using more power, the clock speed of the processing unit is reduced so that more power is available for the peripheral device to perform the task. The peripheral device performs the task using the additional power and then indicates the peripheral device no longer requires the additional power. When the peripheral device indicates the peripheral device no longer requires the additional power, the processing unit's clock speed is reset to the original clock speed.

In one embodiment, when a peripheral device is connected to a powered port, such as a universal serial bus port, the peripheral device indicates how much power the peripheral device uses. A software process, such as power manager 334 in FIG. 3, keeps track of the total power requirements of all the peripheral devices connected to the point of sale terminal. If the software process calculates that total power demand exceeds the available power, then the processing unit's speed is slowed down to a speed that will accommodate the total power demand.

The software process may calculate the total power demand each time a new peripheral device is connected to, or disconnected from, the point of sale terminal. If the software process calculates that total power demand exceeds the available power, the software process may automatically slow down the processing unit's speed, or the software process notifies the user that total power demand exceeds the available power. When the user is notified, the user can choose to remove one or more peripheral devices to reduce total power usage or reduce the speed of the processing unit.

When the peripheral device is connected to the powered port, if the peripheral device does not indicate how much power the peripheral device uses, the software process may measure the peripheral device's power usage. For example, when a peripheral device is connected to a powered port, the software process may use a current shunt and analog the digital converter attached to the powered port to measure the power usage of the peripheral device.

The flowchart and block diagrams in the figures illustrate the architecture, functionality, and operation of some possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing power usage in a data processing system, the computer implemented method comprising:
monitoring the power usage by a set of input/output devices attached to the data processing system;
determining whether a change in the power usage by the set of input/output devices requires a change in power consumption by a processing unit; and
responsive to determining that the change in the power usage requires the change in the power consumption by the processing unit, changing a clock speed of the processing unit.

2. The computer implemented method of claim 1, wherein the data processing system is a point of sale terminal used to process sales transactions.

3. The computer implemented method of claim 1, further comprising:
responsive to the determination that the change in power usage requires a decrease in power consumption by the processing unit, reducing the clock speed of the processing unit to reduce power consumption by the processing unit, wherein additional power is available for use by the set of input/output devices.

4. The computer implemented method of claim 1, further comprising:
responsive to the determination that the change in power usage requires an increase in power consumption by the processing unit, increasing the clock speed of the processing unit to increase power consumption by the processing unit, wherein power available for use by the set of input/output devices is reduced.

5. The computer implemented method of claim 1, wherein monitoring the power usage comprises receiving a message from an input/output device.

6. The computer implemented method of claim 5, wherein the input/output device sends the message responsive to the input/output device being attached to the data processing system.

7. The computer implemented method of claim 6, wherein monitoring the power usage comprises measuring the power usage of the input/output device.

8. A computer program product comprising a computer usable medium including computer usable program code for managing power usage in a data processing system, the computer program product comprising:
computer usable code for monitoring the power usage by a set of input/output devices attached to the data processing system;
computer usable code for determining whether the power usage by the set of input/output devices requires a change in power consumption by a processing unit; and
responsive to a determination that the change in the power usage requires the change in the power consumption by the processing unit, computer usable code for changing a clock speed of the processing unit.

9. The computer program product of claim 8, wherein the data processing system is a point of sale terminal used to process sales transactions.

10. The computer program product of claim 8, further comprising:
responsive to a determination that the change in power usage requires a decrease in power consumption by the processing unit, computer usable code for reducing the clock speed of the processing unit to reduce power consumption by the processing unit, wherein additional power is available for use by the set of input/output devices.

11. The computer program product of claim 8, further comprising:
responsive to a determination that the change in the power usage requires an increase in the power consumption by the processing unit, computer usable code for increasing the clock speed of the processing unit to increase power consumption by the processing unit, wherein the power available for use by the set of input/output devices is reduced.

12. The computer program product of claim 8, wherein monitoring the power usage comprises computer usable code for receiving a message from an input/output device.

13. The computer program product of claim 12, wherein the computer usable code sends the message responsive to the input/output device being attached to the data processing system.

14. The computer program product of claim 13, wherein monitoring the power usage comprises measuring the power usage of the input/output device.

15. A data processing system comprising:
a bus;
a storage device connected to the device, wherein the storage device contains computer usable code;
a communications unit connected to the bus; and
a processing unit connected to the bus for executing the computer usable code, wherein the processing unit monitors power usage by a set of input/output devices attached to the data processing system, determines whether the power usage by the set of input/output devices requires a change in power consumption by the processing unit, and responsive to determining that the change in power usage requires a change in power consumption by the processing unit, changes a clock speed of the processing unit.

16. The data processing system of claim 15, wherein the data processing system is a point of sale terminal used to process sales transactions.

17. The data processing system of claim 15, further comprising:
the processing unit, responsive to determining that the change in power usage requires a decrease in power consumption by the processing unit, reduces the clock speed of the processing unit to reduce the power consumption by the processing unit, wherein additional power is available for use by the set of input/output devices.

18. The data processing system of claim 15, further comprising:
the processing unit, responsive to determining that the change in power usage requires an increase in power consumption by the processing unit, increases the clock speed of the processing unit to increase power consumption by the processing unit, wherein the power available for use by the set of input/output devices is reduced.

19. The data processing system of claim 15, wherein monitoring the power usage comprises receiving a message from an input/output device responsive to the input/output device being attached to the data processing system.

20. The data processing system of claim 19, wherein the processing unit monitors the power usage by measuring the power usage of the input/output device.
